(19) United States
(12) Patent Application Publication
(10) Pub. No.: US 2013/0189036 A1
(43) Pub. Date: Jul. 25, 2013

(54) DAMAGE PREVENTION IN SUBSEA CABLES AND SIMILAR ELEMENTS DURING LAYING OR RETRIEVING

(71) Applicant: Magne Oldervoll, Os (NO)

(72) Inventor: Magne Oldervoll, Os (NO)

(73) Assignee: OCTIO GEOPHYSICAL AS, Bergen (NO)

(21) Appl. No.: 13/521,677

(22) PCT Filed: Jan. 25, 2010
(86) PCT No.: PCT/IB2010/050315

§ 371 Date: Mar. 19, 2013

(51) Int. Cl. F16L 1/16

(52) U.S. Cl. CPC F16L 1/16
USPC 405/168.3

(57) ABSTRACT

To eliminate the risk of damaging an elongate flexible element and/or an accessory integrated therein, such as a seismic cable having sensor modules distributed rather densely along the cable and forming therewith sections that risk being damaged, on passing from a generally horizontal/vertical orientation to a generally vertical/horizontal one during subsea laying or retrieving of the cable, a new direction changing support structure is provided. The support structure comprises at least two rotary sheaves and a rotary support frame for carrying the sheaves, and said at least two sheaves are spaced from each other a distance that is greater than a length of the accessory to permit the element with the integral accessory to extend in a straight line between the two sheaves. Each sheave has a rotational axis that is parallel to a rotational axis of the support frame, and the support frame is rotary at least between a position in which the accessory with associated ends of the element is located in a generally horizontal orientation and is supported by said sheaves and a position in which the accessory with associated ends of the element is located in a generally vertical orientation during continuous support by said sheaves.

### TECHNICAL FIELD

The present invention relates to a method of preventing damage in an elongate flexible element having an accessory integral with the element and forming therewith a section that risks being damaged on passing from a generally horizontal/vertical orientation to a generally vertical/horizontal one during subsea laying or retrieving of the element.

The invention also relates to a support structure for an elongate flexible element having an accessory integral with the element and forming therewith a section that risks being damaged on passing from a generally horizontal/vertical orientation to a generally vertical/horizontal one during subsea laying or retrieving of the element.

The term “element” as used herein is intended to encompass subsea elements such as seabed pipes and cables, such as seismic cables, for example, which have sensor modules distributed rather densely along the cable. Such sensor modules form an example of an accessory that is integral with the elongate flexible element, but the accessories are not restricted to such sensor modules.

### BACKGROUND ART

Different technologies for deploying and retrieving subsea cables to the seabed exist. The general concept for deployment is either a linear traction unit or a winch. In the first case, cable from a cable storage is fed by a traction unit over an overboard unit, where the cable changes direction from horizontal to vertical. As an example, the traction unit may comprise a series of driven wheel or belt nips, and the overboard unit may be a simple wheel that changes the feed direction of the cable. In the second case, the cable is stored on a winch, from which it is spooled out by a drive motor.

There is a wide range of technologies used in cable deployment. The cable can either be spooled out from a winch or drum, or it can be supplied from a storage container or a rotary table (carousel). For short and/or thin cables the winch alternative is often used, but for lager cables this is normally not a good solution. For big power cables and long telecom cables it is common practice to store the cable on a “carousel”.

The cable tension can be controlled by a linear traction machine or a capstan, or if the cable is deployed from a winch, the winch could be used to control the tension and hold back the cable. The traction machines are often based on wheels or belts squeezing on the outside of the cable. This can be a problem if the cable is of a fragile design, or contains fragile components such as sensor modules or connectors. Also if the cable is deployed from a winch, and the tension is high, there can be damages to a fragile cable or module.

To get the cable from the horizontal plane onboard the vessel, to the vertical plane in the water column it is common practice to run the cable over a sheave-wheel or a chute at the stem or side of the vessel. If the system to be deployed only contains cable, without any stiff modules like sensor modules or connectors integrated into the cable, this is simple and acceptable way to do the deployment. The problem occurs when there is a stiff unit integrated in the cable, because then the cable gets a sharp bend or kink where it enters the stiff unit. This may destroy the cable, as it is designed with a minimum bend radius, and this kink is far sharper than permitted by the minimum bend radius. Often this problem is solved to some extent by adding bend restrictors at each end of the stiff module. The problem may also be reduced by increasing the diameter of the wheel compared to the length of the unit. However, this will only reduce the problem, not eliminate it.

U.S. Pat. No. 4,714,380 discloses various mechanisms for lifting an elongate flexible element, which has an accessory that is integral with the element and forms therewith a stiff section, up from the periphery of the direction changing wheel in order to increase the bend radius. A conventional device for linear traction of the element, e.g. opposed caterpillar tracks, is controlled to avoid tension in the element between the traction device and the lifting mechanism, so that a bend in the element, where the element exits the accessory, will be smooth.

A similar concept but more elaborated is disclosed in U.S. Pat. No. 5,580,187. Here, two curved conveyors are substituted for the direction changing wheel to give a larger radius of curvature. A trolley for supporting the accessory, so that the element at each end of the accessory is not subject to bending, is movable along the curved conveyors.

However, also these two concepts will only reduce the problem, not eliminate it.

### SUMMARY OF THE INVENTION

The object of the present invention is to eliminate the risk of damaging the elongate flexible element and/or its integrated accessory on passage thereof over a direction changing support structure.

In a method of the kind referred to in the first paragraph above, this object is achieved in accordance with the invention by carrying out the following steps:
a) providing a support structure including at least two rotary sheaves and a rotary support frame for carrying the sheaves, said at least two sheaves being spaced from each other a distance that is greater than a length of the accessory to permit the element with the integral accessory to extend in a straight line between the two sheaves, each sheave having a rotational axis that is substantially parallel to a rotational axis of the support frame;
b) feeding the element to a position where it is carried by said at least two sheaves and the integral accessory is located between said two sheaves;
c) rotating the support frame to make the accessory change from a generally horizontal/vertical orientation to a generally vertical/horizontal one while maintaining the location of the accessory between the sheaves; and
d) continuing feeding the element to make the accessory leave the position between the sheaves, whereby the accessory and adjacent sections of the element have changed their orientation during rotation of the support frame a quarter of a full turn without having been exposed to damaging bends.

Similarly, the object is also achieved in a support structure of the kind referred to in the second paragraph above, in that said support structure comprises at least two rotary sheaves and a rotary support frame for carrying the sheaves, said at least two sheaves being spaced from each other a distance that is greater than a length of the accessory to permit the element with the integral accessory to extend in a straight line between the two sheaves, each sheave having a rotational axis that is substantially parallel to a rotational axis of the support frame, and the support frame being rotary at least between a position in which the accessory with associated ends of the element is located in a generally horizontal orientation and is supported by said sheaves and a position in which the accessory with associated ends of the element is located in a generally vertical orientation during continuous support by said sheaves.

Thus, both the method and the support structure of the present invention make it possible to change the orientation of the accessory and adjacent sections of the element from generally horizontal to generally vertical, when laying an elongate flexible subsea element or from generally vertical to generally horizontal when retrieving the element, without exposing the accessory and adjacent sections of the element to damaging bends.

In the present context, the term “sheave” is used to designate a wheel or roller with a groove along its edge for guiding a cable or similar elongate flexible element while changing the running direction of the cable or other element.

Even though the support structure will work in the intended manner when having only two rotary sheaves, the support structure advantageously comprises more than two rotary sheaves, preferably four sheaves, that are carried by the rotary support frame, and the sheaves are equidistantly spaced from the rotational axis of the rotary frame and equiangularly spaced from one another. Thus, in an embodiment with four sheaves, they are located at the corners of a square.

In a preferred embodiment, the support structure is part of an overboard unit. Then, the sheaves have a circumferential groove fitting the element that engages the sheave, the sheaves and the support frame can rotate freely, a tensioning unit is provided upstream of the support structure to keep a desired tension in the element, and a locking system is provided for preventing the support frame to rotate when it should not.

If desired, arcuate rows of wheels provided with circumferential grooves may be substituted for large diameter sheaves.

In another preferred embodiment, the support structure is part of a combined overboard unit and traction unit. Then, the sheaves have a circumferential groove giving place for more than one single element to engage the sheave, and the support frame and all of the sheaves are motor driven, the support frame and all of the sheaves each have a separate motor, and the motors are individually controlled. The element carried by the sheaves is wrapped around the support frame one or more times. Preferably, a guiding system for the element is provided on the circumference of the sheaves for moving the element from one side of the support frame to the other as the sheaves rotate, so as to prevent the element from getting tangled up at one side of the support frame.

Further details characterizing the present invention will be disclosed below.

### BRIEF DESCRIPTION OF THE DRAWINGS

In the following, the invention will be described in more detail with reference to preferred embodiments and the appended drawings.

FIG. 1 is a schematic side view of a ship for laying an elongate flexible subsea element with integrated accessories, e.g. a seismic cable with sensor modules, said ship having a support structure for changing the orientation of the cable during laying from generally horizontal to generally vertical.

FIG. 2 is a side view of the support structure of FIG. 1 of an overboard unit and comprising a support frame and rotary sheaves in accordance with a preferred embodiment of the present invention.

FIG. 3 is an end view of the support structure of FIG. 2.

FIGS. 4a to 4d is a sequence of side views of the overboard unit in operation, with the flexible element passing the support structure of FIG. 2 and
a) showing an integrated accessory arriving at the support frame,
b) showing the accessory and adjacent parts of the element located between and carried horizontally by the two upper sheaves,
c) showing the support frame rotated an eighth of a full turn, and
d) showing the support frame having completed a quarter of a full turn, so that the accessory is carried vertically and just has left its position between the sheaves.

FIG. 5 is a side view of an alternative preferred embodiment an overboard unit of the present invention and comprising a support frame and roller-shaped rotary sheaves, the support frame being shown in a first locked position with a just arrived horizontal integrated accessory, a locking system including a cam wheel being provided for preventing the support frame from rotating when it should not.

FIG. 6 is a top view of the overboard unit of FIG. 5 showing inter alia the series of roller-shaped sheaves.

FIG. 7 is a side view of the overboard unit of FIG. 5 with the support frame shown in a position midway between a first locked position for horizontal receipt of the arriving integrated accessory, and a second locked position for vertical delivery of the integrated accessory.

FIG. 8 is a perspective view of the overboard unit of FIG. 5.

FIG. 9 is a sectional side view of part of the top portion of the support frame of FIG. 5 on a larger scale taken along line IX-IX of FIG. 6 and shows the horizontal integrated accessory arriving at and engaging a pivotal hook included in the locking system.

FIG. 10 is a sectional side view of part of the top portion of the support frame on a larger scale after rotation to the position shown in FIG. 7 and shows the horizontal integrated accessory having swung the pivotal hook of the locking system aside, so that the support frame can continue rotating to a subsequent locked position, where the integrated accessory is vertical.

FIG. 11 is a side view of the support structure of FIG. 1 of a combined overboard unit and traction unit and comprising a support frame and rotary sheaves in accordance with another preferred embodiment of the present invention.

FIG. 12 is an end view of the support structure of FIG. 11.

FIGS. 13a and 13b is a schematic top view and perspective view, respectively, of a guiding system for the element to permit the element to extend more than one full turn around the support frame while preventing the element from getting tangled up at one side of the support frame.

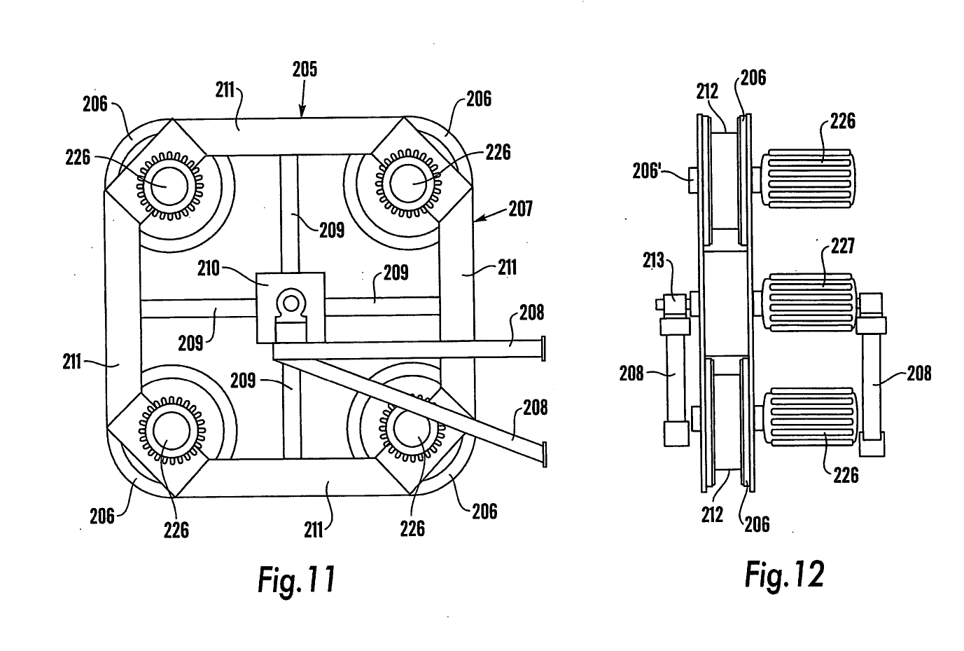

FIGS. 14a to 14d is a sequence of side views of the combined overboard unit and traction unit in operation, with the flexible element wrapped around the support frame of FIG. 11 and
a) showing an integrated accessory arriving at the support frame,
b) showing the accessory and adjacent parts of the element located between and carried horizontally by the two upper sheaves,
c) showing the support frame rotated a half of a full turn, and
d) showing the support frame having completed one and a quarter of a full turn, so that the accessory is carried vertically and just has left its position between the sheaves.

### MODE(S) FOR CARRYING OUT THE INVENTION

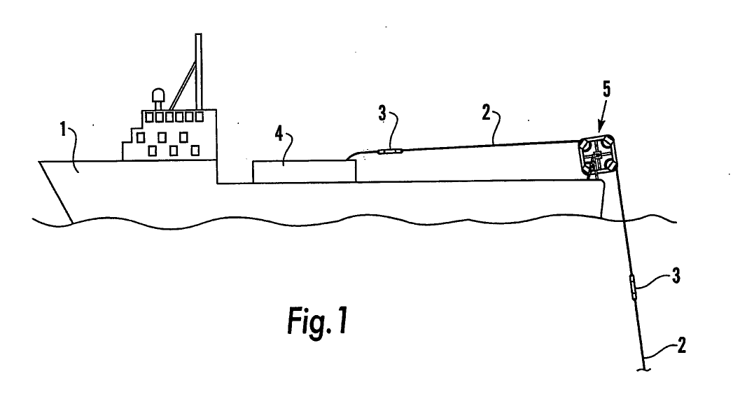

FIG. 1 is a schematic side view of a ship 1 for laying and retrieving an elongate flexible subsea element 2 with integrated accessories 3. The elongate flexible subsea element may be a seabed pipe or a cable, such as a seismic cable, for example, which has sensor modules distributed rather densely along the cable. Such sensor modules form an example of an accessory that is integral with the elongate flexible element, but the accessories are not restricted to such sensor modules. Another example is a connector. The cable 2 or other elongate flexible element is supplied from a supply device 4, which includes either a storage container or a rotary table (carousel), or alternatively a winch or drum. For short and/or thin cables the winch alternative is often used, but for thick cables this is normally not a good solution. For heavy power cables and long telecom cables it is common practice to store the cable on a carousel.

The supply device 4 also includes either a linear traction unit or a winch. In the first case, cable from the cable storage is fed by the traction unit over a support structure 5, where the cable changes direction from horizontal to vertical. As an example, the traction unit may comprise a series of driven wheel nips or belt nips, while in the second case the cable is stored on a winch, from which it is spooled out by a drive motor. The traction machines are often based on wheels or belts squeezing on the outside of the cable. This can be a problem if the cable is of a fragile design, or contains fragile components such as sensor modules or connectors.

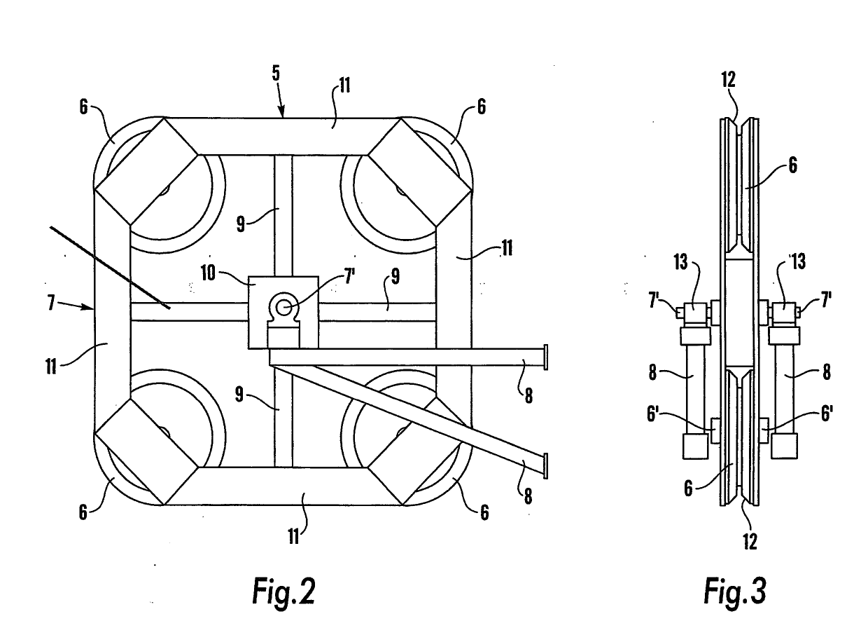

FIG. 2 is a side view on an enlarged scale of the support structure 5 shown in FIG. 1, where it is an overboard unit. In accordance with a preferred embodiment of the present invention it comprises at least two rotary sheaves 6 and a rotary support frame 7 for carrying the sheaves. The at least two sheaves are spaced from each other a distance that is greater than a length of the accessory 3 to permit the element 2 with the integral accessory to extend in a straight line between the two sheaves 6, and each sheave has a rotational axis 6′ that is parallel to a rotational axis 7′ of the support frame 7. A bracket 8 is mounted to the stern of the ship 1 for carrying the rotary support frame 7. The sheaves 6 have an effective radius of curvature that is larger than the minimum permissible bend radius of the element 2.

The support frame 7 is rotary at least between a first position in which the accessory 3 with associated ends of the element 2 has a generally horizontal orientation and is supported by the at least two sheaves 6, and a second position in which the accessory 3 with associated ends of the element 2 has a generally vertical orientation. During the rotation of the support frame 7, the accessory 3 does not move in relation to the at least two sheaves and it is continuously supported by the sheaves 6.

In a simple embodiment, not shown, the support frame 7 may be a straight arm. The two sheaves 6 are located at the ends of the arm, and the arm can rotate around its center. Then, the bracket 8 has to project rearward from the stern of the ship 1 to permit to permit the arm to rotate a quarter of a full turn from a generally horizontal orientation to a generally vertical one, or the other way around. After having made the quarter of a full turn and delivered the stiff section, the arm swings back to its original position for receiving the next stiff section and repeating the action. Instead of being straight, the arm may be angular, and the two halves of the arm may form a straight angle, for example, between them.

In another embodiment, not shown, two identical arms having rotary sheaves at their ends may cross each other perpendicularly to form a substantially square rotary support frame having the sheaves located in the corners of the square. Of course, to make the support frame sufficiently stable, the two arms may have to be interconnected by struts.

A preferred embodiment of a support frame 7 having four sheaves 6 located at the corners of a square is shown in FIG. 2. Here, the support frame 7 has four spokes 9 extending between a hub 10 and a surrounding generally square frame 11. The very corners of the square are beveled to give the support frame 7 an octagonal shape, and the four rotary sheaves 6 are mounted at the beveled corners. In all of the embodiments described above, the sheaves 6 preferably are equidistantly spaced from the rotational axis of the rotary frame 7 and equiangularly spaced from one another. In this design, all rotations of the support frame 7 a quarter of a full turn will be in the same direction, not back to its previous position, and the bracket 8 does not have to project rearward from the stern of the ship 1. FIG. 3 is an end view of the support structure of FIG. 2. As shown, the sheaves 6 are provided with a circumferential groove 12 fitting the element 2 that engages the sheave. Further, it is clear that the rotary support frame 7 is mounted in bearings 13 carried by a forked end of the bracket 8.

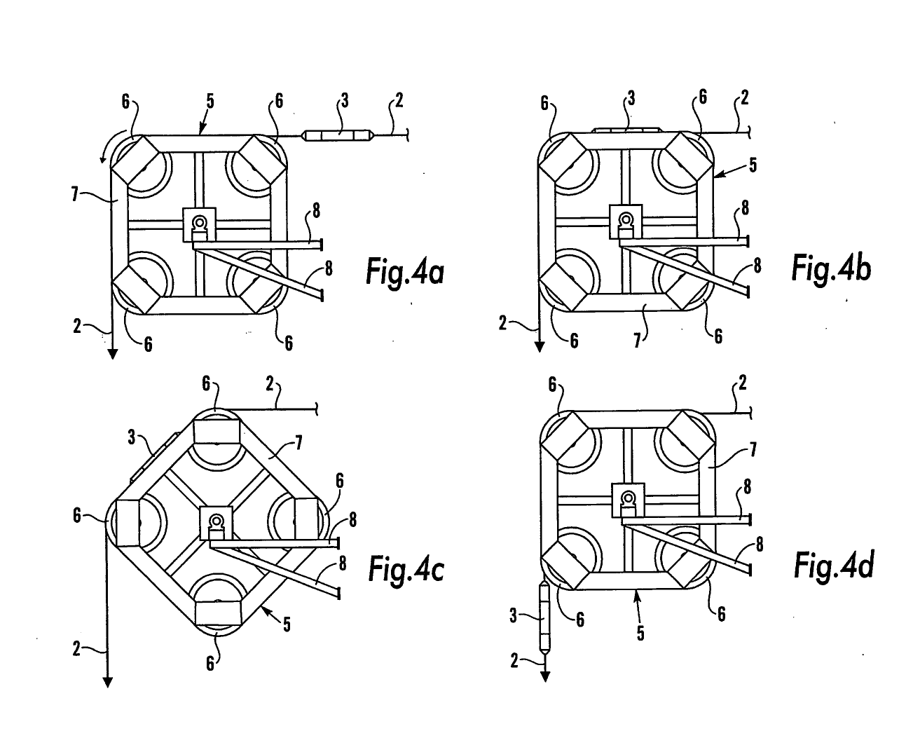

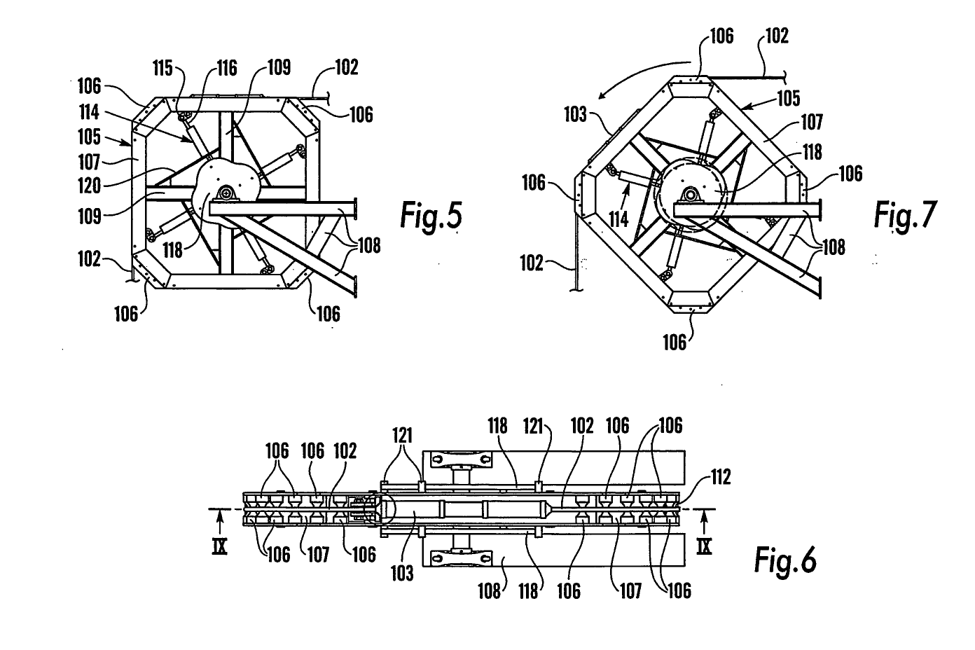

As disclosed above, the support frame 7 can rotate around its own center, and the sheaves 6 at the corners of the frame can rotate freely. There is also a locking system keeping the support frame 7 from rotating when it should not. It can be made as a pure mechanical device, or it can be an electrical or hydraulic system. This system will require a traction unit to hold the cable tension. This is not shown in the figure, but it could be a conventional linear traction unit or a capstan, placed in front of the overboard unit. A mechanical locking system will be described in the following in connection with FIGS. 5-10.

FIGS. 4a to 4d is a sequence of side views of the overboard unit in operation, with the flexible element 2 passing the support structure 5 of FIG. 2. When the element 2, without any stiff accessories 3, is laid, it passes over the overboard unit as shown in FIG. 4a. The element 2 rolls over the upper left sheave 6, and the support frame 7 is kept from rotating by the locking system. Only the friction force in the sheave 6 will try to rotate the support frame 7, all other forces are balanced, and the force needed to keep the support frame 7 from rotating is small.

When a stiff module or other accessory 3 reaches the overboard unit, it will get to a position halfway between the two upper sheaves 6, as shown in FIG. 4b. At this point the locking system is released, and the support frame 7 can rotate freely with no relative movement between the element 2 and the support frame 7. Additional functions, not shown, can lock the accessory 3 to the support frame 7 to avoid slippage. The result will be that the support frame 7 rotates with the element 2, and the stiff module or other accessory 3 is protected from any bending forces as shown in FIG. 4c.

When the support frame 7 has rotated about a quarter of a full turn, the locking system is engaged again, preventing the support frame 7 from rotating any more. The element 6 now can continue rolling over the upper left-hand wheel in FIG. 4d until the next stiff module or other accessory 6 arrives at the overboard unit.

An alternative preferred embodiment of the support structure of the present invention is shown in FIGS. 5 to 10. In view of the similarities between the embodiment of FIGS. 5-10 and that of FIGS. 2-4, in principle only the differences will be described, and basically the same reference numerals will be used but chosen from the 100-series. As an example, the support structure 5 in the embodiment of FIGS. 2-4 will be referred to as support structure 105 in the embodiment of FIGS. 5-10.

Thus, FIG. 5 is a side view of the support structure 105 of FIG. 1 of an overboard unit, and it comprises a generally square support frame 107 and four rotary sheaves 106, one at each corner of the square. A first difference is that the rotary sheaves here are roller-shaped and preceded by and followed by additional roller-shaped sheaves 106, which together form an arcuate path for the element 102, which path has a radius of curvature that is of the same size as the radius of a single sheave of larger diameter carried by the rotary support frame 107 would have, if provided. Thus, the arcuate path formed by the roller-shaped sheaves 106 is identical to the circle arc of a 90 degree sector of a sheave 6 in the embodiment of FIGS. 2-4. The preferred shape of the roller-shaped sheaves 106 is best shown in FIG. 6.

A second difference is that the support structure 105 is provided with a system for locking the support frame 107 in various desired positions. Many rotation preventing systems, mechanical or not, are conceivable for a skilled art worker, but in the embodiment shown in FIGS. 5-10, the rotation locking system is generally designated 114 and comprises four sets of a two-armed pivotal hook 115, a push-rod 116, a spring 117, and a central non-rotary cam wheel 118 common to all sets. As best shown in FIG. 10, the pivotal hook 115 has two ends, one of which is shaped for engagement with a forward end of the arriving generally horizontal integral accessory 103. The push rod 116 has one end pivotally connected to the other end of the hook 115 and extends from there toward the rotational axis of the support frame 107. The cam wheel 118 has a cam surface including four equidistantly and equiangularly spaced cam tops and intermediate valleys and is coaxial with the support frame 107 but is fixed and does not rotate.

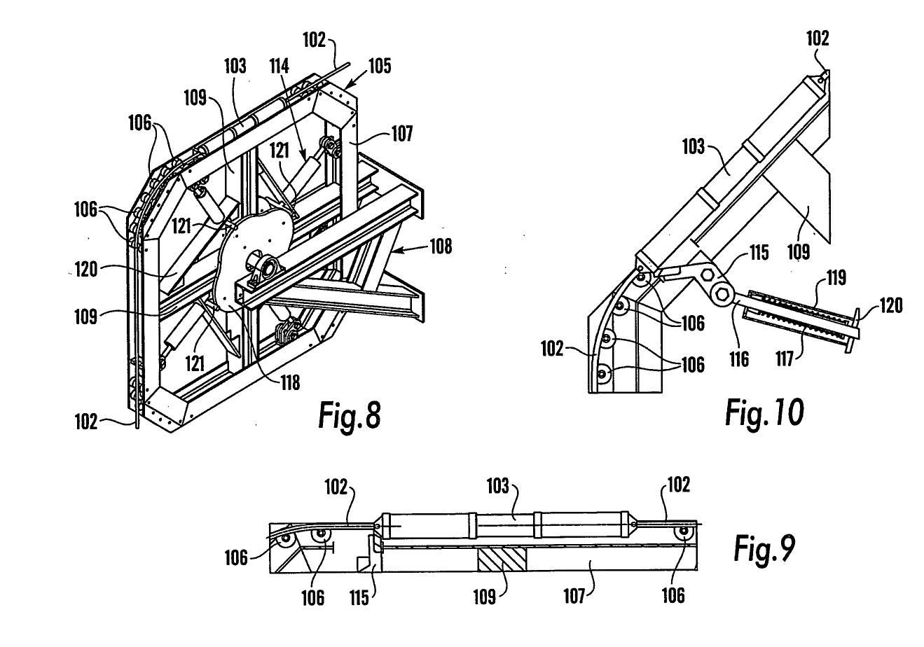

The spring 117 is either a compression spring or a tension spring, and it is arranged to press the other end of the push-rod 116 against the cam surface provided on the cam wheel 118. In the embodiment shown in FIGS. 5-10, two identical cam wheels 118 are used, one on each side of the support frame 107 but not connected thereto, and the push rod 116 has a T-shaped end 121 (best shown in FIGS. 6 and 8) that engages the cam surfaces on both of the cam wheels 118. Further, the spring 117 is surrounded by a housing 119 (best shown in FIG. 10) standing on a support member 120 extending at a substantially right angle to the push rod 116 and from one spoke 109 to another. In FIG. 5, the support frame 107 is shown in a first locked position, and a forward end of a just arrived horizontal accessory 103 is stopped by the hook 115 as is best shown in FIG. 9. When the pulling force from the elongate flexible element 102 causes the rotary support frame 107 to rotate, the push rod 116 goes from a cam top to an adjacent valley and thereby swings the hook 115 out of locking engagement with forward end of the accessory 103. After rotation of the support frame 107 an eighth of a full turn from the locked position shown in FIG. 5, it is in the free position shown in FIG. 7, and the push rod 116 is at the bottom of the cam valley, and the integral accessory 103 has moved forward to the roller shaped sheave 106 in front as is best shown in FIG. 10. A continued rotation another eighth of a full turn will bring the support frame 107 to a position where it again becomes locked against further rotation and the accessory 103 is permitted to leave the support frame 107 in a generally vertical direction. Then, the elongate flexible element 102 can be pulled freely over the direction changing locked support structure 105 until the next integral accessory 103 arrives. A reason for the locking effect is that the friction in the bearings of the roller-shaped sheaves during deployment of a cable or other elongate flexible element is smaller than the combined friction of the support frame bearings and of the push rods that move axially and slide on the cam wheels.

A different alternative can be an electrically operated locking system, not shown. This will have an electric sensor, which detects when an integral accessory 103 gets into the support frame 107 and then releases an electrically operated lock. When the support frame 107 has rotated 90 degrees, other detectors will sense this and turn the lock on again.

An alternative preferred embodiment of the support structure of the present invention is shown in FIGS. 11 to 15. In view of the similarities between the embodiment of FIGS. 11-15 and that of FIGS. 2-4, in principle only the differences will be described, and basically the same reference numerals will be used but chosen from the 200-series. As an example, the support structure 5 in the embodiment of FIGS. 2-4 will be referred to as support structure 205 in the embodiment of FIGS. 11-15.

Thus, FIG. 11 is a side view of the support structure 205 of FIG. 1 of a combined overboard unit and fraction unit, and it comprises a support frame 207 and rotary sheaves 206, and FIG. 12 is an end view of the support structure of FIG. 11. A first difference is that every one of the four sheaves 206 is equipped with a motor 226 for driving it. Also the support frame 207 itself is rotated by a motor 227. The profile of the sheaves 206 is also different, in that the circumferential groove 212 has a flat bottom and gives room for more than one single element 202 to pass the sheave 206.

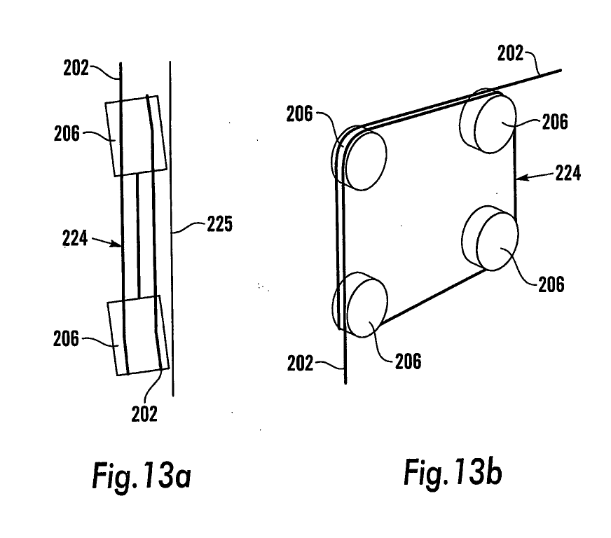

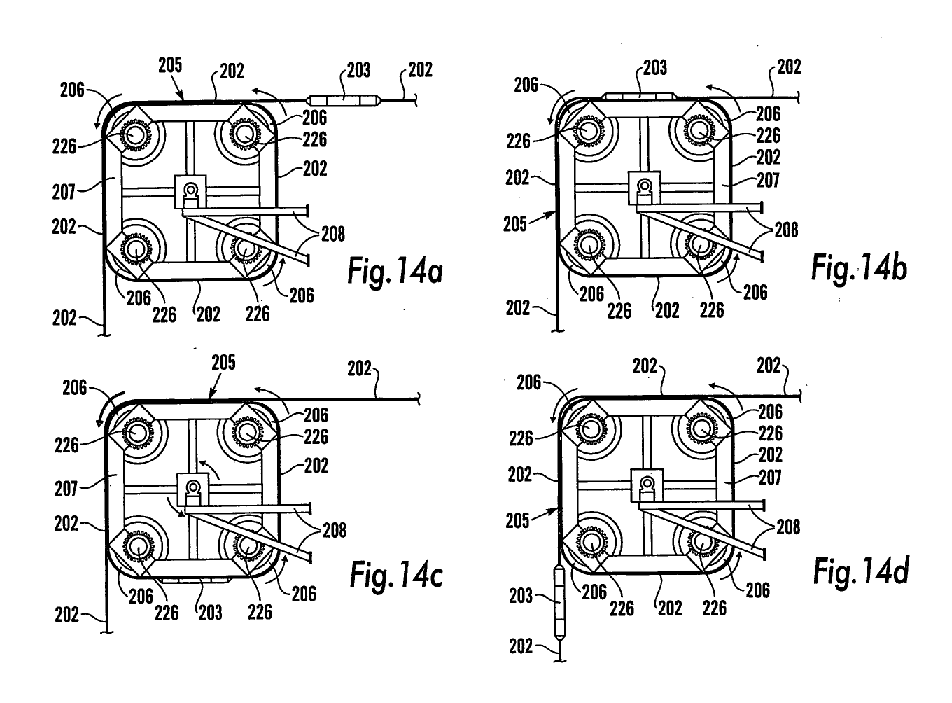

There is also a guiding system for moving the element 202 in the grooves 212 of the sheaves 206 from one side to the other of the support frame 207 as the sheaves 206 rotate, so as to permit the element 202 to extend more than one full turn around the support frame 207 while preventing the element 202 from getting tangled up at one side of the support frame 207. Various guiding systems may be used, but a simple one, generally designated 224, is schematically shown in FIGS. 13a and 13b. As shown in the top view of FIG. 13a, the rotary sheaves 206 are located in such a manner that their rotational axes are parallel to one another but form an angle close to but deviating from 90 degrees with a vertical plane 225 through identically located points of the four sheaves 206 in the combined overboard and traction unit. The vertical plane 225 is parallel to the rotational plane of the support frame 207. Every time the elongate flexible element 202 bends over anyone of the sheaves 206, it is moved sideways. In FIGS. 13a and 13b, the skew is exaggerated for illustration purposes.

The motors 226 and 227 that are used to control the sheaves 206 and the support frame 207 will typically be electric motors with individual control system for each. The control system will control the rotational speed and tension of the sheaves 206 and the support frame 207. To provide power and control signals to the sheave motors 226, a slip ring may be included in the support frame 207. Preferably, a common AC power is supplied over the slip rings to the four motors 226, whereas the last motor 227 may be powered directly, without going through the slip ring. Preferably there is a distribution and control unit mounted on the support frame 207. All of this is standard, off the shelf technology, and should not require a detailed description.

FIGS. 14a to 14d is a sequence of side views of the combined overboard and traction unit in operation, with the flexible element 202 passing the support structure 205 of FIG. 11. The flexible element 202 is wrapped around the support frame 207 one or more times. In a situation when only the flexible element 202 is deployed, this is done by breaking the support frame 207 to hold it still and simultaneously rotating the sheaves 206. By controlling the tension on each sheave 206, the load is distributed to multiple points on the flexible element 202, and by that the flexible element 202 is less exposed to damage.

When a stiff module or other accessory 203 gets into the position midway between the two upper sheaves 206 in FIG. 15b, the sheaves 206 will stop and the support frame 207 will start rotating. The support frame 207 will rotate the number of turns the flexible element 202 is wrapped around it, such that the stiff module or other accessory 203 gets out on the other side as shown in FIG. 15d. The support frame 207 will now stop, and the sheaves 206 will continue to pay out the flexible element 202.

Although the present invention is described above only in connection with the subsea laying of an elongate flexible element 2, 102, 202, which has an accessory 3, 103, 203 integral with the element and forms therewith a section, for instance a substantially stiff section, that risks being damaged on passing from a generally horizontal/vertical orientation to a generally vertical/horizontal one, it is obvious the it also can be used in retrieving such an elongate flexible element 2, 102, 202 from the seabed.

### INDUSTRIAL APPLICABILITY

The method and the support structure of the present invention are applicable to eliminate the risk of damaging an elongate flexible element and/or an accessory integrated therein, such as a seismic cable having sensor modules distributed rather densely along the cable and forming therewith stiff sections that risk being damaged, on passing from a generally horizontal/vertical orientation to a generally vertical/horizontal one during subsea laying or retrieving of the cable.

1-24. (canceled)

25. A method of preventing damage in an elongate flexible element having an accessory integral with the element and forming therewith a section that risks being damaged on passing from a generally horizontal/vertical orientation to a generally vertical/horizontal one during subsea laying or retrieving of the element, comprising:
a) providing a support structure including at least two rotary sheaves; and a rotary support frame for carrying the sheaves, said at least two sheaves being spaced from each other a distance that is greater than a length of the accessory to permit the element with the integral accessory to extend in a straight line between the two sheaves, each sheave having a rotational axis that is substantially parallel to a rotational axis of the support frame;
b) feeding the element to a position where it is carried by said at least two sheaves and the integral accessory is located between said two sheaves;
c) rotating the support frame to make the accessory change from a generally horizontal/vertical orientation to a generally vertical/horizontal one while maintaining the location of the accessory between the sheaves; and
d) continuing feeding the element to make the accessory leave the position between the sheaves, whereby the accessory and adjacent sections of the element have changed their orientation frame a quarter of a full turn without having been exposed to damaging bends.

26. The method according to claim 25, comprising providing the support structure with more than two rotary sheaves carried by the rotary support frame, and spacing said sheaves equidistantly from the rotational axis of the rotary frame and equiangularly from one another.

27. The method according to claim 26, comprising providing the support structure with four rotary sheaves.

28. The method according to claim 25, comprising providing the sheaves with a circumferential groove fitting the element that engages the sheave.

29. The method according to claim 25, comprising mounting the sheaves and the support frame to rotate freely, and providing a tensioning unit to keep a desired tension in the element.

30. The method according to claim 29, comprising providing a locking system for preventing the support frame from rotating when it should not.

31. The method according to claim 30, wherein said sheaves being roller-shaped and being preceded by and followed by additional roller-shaped sheaves, which together form an arcuate path for the element, said path having a radius of curvature that is of the same size as the radius of a single sheave of larger diameter carried by the rotary support frame would have.

32. The method according to claim 25, comprising providing the sheaves with a circumferential groove giving place for more than one single element to engage the sheave, and providing motors for driving the support frame and all of the sheaves.

33. The method according to claim 32, comprising providing a separate motor for each of the support frame and all of the sheaves.

34. The method according to claim 33, comprising controlling the motors individually.

35. The method according to claim 34, comprising providing a guiding system for moving the element on the circumference of the sheaves from one side of the support frame to the other as the sheaves rotate, so as to permit the element to extend more than one full turn around the support frame while preventing the element from getting tangled up at one side of the support frame.

36. A support structure for an elongate flexible element having an accessory integral with the element and forming therewith a section that risks being damaged on passing from a generally horizontal/vertical orientation to a generally vertical/horizontal one during subsea laying or retrieving of the element, said support structure comprising:
at least two rotary sheaves and a rotary support frame for carrying the sheaves, said at least two sheaves being spaced from each other a distance that is greater than a length of the accessory to permit the element with the integral accessory to extend in a straight line between the two sheaves, each sheave having a rotational axis that is substantially parallel to a rotational axis of the support frame, and the support frame being rotary at least between a position in which the accessory with associated ends of the element is located in a generally horizontal orientation and is supported by said sheaves and a position in which the accessory with associated ends of the element is located in a generally vertical orientation during continuous support by said sheaves.

37. The support structure according to claim 36, wherein the support structure comprises more than two rotary sheaves carried by the rotary support frame, said sheaves being equidistantly spaced from the rotational axis of the rotary frame and equiangularly spaced from one another.

38. The support structure according to claim 37, wherein the support structure comprises four rotary sheaves.

39. The support structure according to claim 36, wherein the sheaves have a circumferential groove fitting the element that engages the sheave.

40. The support structure according to claim 39, wherein the sheaves and the support frame can rotate freely.

41. The support structure according to claim 40, wherein a tensioning unit to keep a desired tension in the element is provided upstream of the support structure.

42. The support structure according to claim 41, wherein a locking system is provided for preventing the support frame from rotating when it should not.

43. The support structure according to claim 36, wherein said sheaves are roller-shaped and are preceded by and followed by additional roller-shaped sheaves, which together form an arcuate path for the element, said path having a radius of curvature that is of the same size as the radius of a single sheave of larger diameter carried by the rotary support frame would have, if provided.

44. The support structure according to claim 43, wherein a locking system is provided for preventing the support frame from rotating when it should not, said locking system including a two-armed pivotal hook, a push-rod, a spring and, a non-rotary cam wheel, the hook having two ends, one of which is shaped for engagement with a forward end of the arriving generally horizontal integral accessory, the push rod having one end pivotally connected to the other end of the hook, and the spring being arranged to press the other end of the push-rod against a cam surface provided on the cam wheel, so that upon engagement of the integral accessory with the hook, the pulling force from the elongate flexible element causes the rotary support frame to rotate first an eighth of a full turn, thereby swinging the hook out of engagement with the accessory, and then another eighth of a full turn to lock the support frame against further rotation and permit the accessory to leave the support frame in a generally vertical direction.

45. The support structure according to claim 36, wherein the sheaves have a circumferential groove giving place for more than one single element to engage the sheave, and the support frame and all of the sheaves being motor driven.

46. The support structure according to claim 45, wherein the support frame and all of the sheaves each have a separate motor.

47. The support structure according to claim 47, wherein the motors are individually controlled.

48. The support structure according to claim 47, wherein a guiding system is provided for moving the element on the circumference of the sheaves from one side of the support frame to the other as the sheaves rotate, so as to permit the element to extend more than one full turn around the support frame while preventing the element from getting tangled up at one side of the support frame.
